(19) United States
(12) Patent Application Publication
(10) Pub. No.: US 2016/0285214 A1
(43) Pub. Date: Sep. 29, 2016

(54) ELECTRIC CONNECTOR ASSEMBLY MATED WITH A MATING CONNECTOR IN TWO ORIENTATIONS

(71) Applicant: FOXCONN INTERCONNECT TECHNOLOGY LIMITED, Grand Cayman (KY)

(72) Inventors: CHI-MING CHEN, New Taipei (TW); DE-GANG ZHANG, Kunshan (CN); HAO JIANG, Kunshan (CN)

(21) Appl. No.: 15/080,609

(22) Filed: Mar. 25, 2016

(30) Foreign Application Priority Data
Mar. 25, 2015 (CN) 201510130318.6

(51) Int. Cl. H01R 24/62; H01R 13/428; H01R 43/20; H01R 13/6581

(52) U.S. Cl. CPC H01R 24/62; H01R 13/6581; H01R 13/428; H01R 43/20; H01R 2107/00

(57) ABSTRACT

A cable connector assembly includes an insulative housing, an upper and a lower row of contacts received by the insulative housing, a printed circuit board assembled on a rear end of the insulative housing and electrically connected with the contacts, a shielding case enclosing the insulative housing; and a cable connected with a rear end of the printed circuit board, wherein the insulative housing includes a main body, a tongue portion positioned on a front end of the main body, and a front end portion separately molded on the tongue portion and on a front end of the contacts, and each of the upper and the lower row of contacts defines a contacting portion projecting outwardly, a fixing portion interference fitted with tongue portion, a tail portion electrically connected with the printed circuit board and a bent portion connected between the fixing portion and the tail portion.

### BACKGROUND OF THE INVENTION

1. Field of the Invention

The present invention relates to an electrical connector assembly, and particularly to an electrical connector assembly for mating with a mating connector in two orientations.

2. Description of Related Art

Universal Serial Bus (USB) as a standard input/output interface is widely used in electronic devices. The USB interface is hot-swappable and has plug and play feature. In all the peripheral interfaces for data transfer and data exchange used in the computers and peripheral date exchange devices, the USB is one of the most widely. Most computer peripherals connect to a computer via USB for data transfer and exchange, such as a mouse, keyboard, U disk, printers, mobile phones, cameras and so on.

U.S. Pat. Nos. 7,094,086 and 7,361,059 each disclose a reversible USB connector.

U.S. Patent Application Publication No. 2014/0206209, published on Jul. 24, 2014, discloses a USB plug connector including a deflectable tongue. In one embodiment, the tongue is formed via a two-shot molding process, as opposed to a one-shot molding process. The first insert molding shot may be used to form a first portion located between the opposing sets of contacts of the electrical connector. The second insert molding shot may be used to form a second portion forming a tip of the tongue.

An improved reversible electrical connector is desired.

### SUMMARY OF THE INVENTION

Accordingly, the object of the present invention is to provide an electrical connector assembly with a reliable locking device.

In order to achieve the object reminded above, a cable connector assembly includes: an insulative housing, an upper row of contacts and a lower row of contacts received by the insulative housing, a printed circuit board assembled on a rear end of the insulative housing and electrically connected with the contacts, a shielding case enclosing the insulative housing; and a cable connected with a rear end of the printed circuit board, wherein the insulative housing includes a main body, a tongue portion positioned on a front end of the main body, and a front end portion formed on a front end of the tongue portion, the front end portion is separately molded on the tongue portion and on a front end of the contacts, and each of the upper row of contacts and the lower row of contacts defines a contacting portion projecting outwardly, a fixing portion interference fitted with tongue portion, a tail portion electrically connected with the printed circuit board and a bent portion connected between the fixing portion and the tail portion.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector assembly in accordance with the present invention;

FIG. 2 is an exploded view of electrical connector assembly shown in FIG. 1;

FIG. 3 is an exploded view in another angle of the electrical connector assembly shown in FIG. 2;

FIG. 4 is a further exploded view of the electrical connector assembly shown in FIG. 2, removing the metal case;

FIG. 5 is an exploded view in another angle of the electrical connector assembly shown in FIG. 4;

FIG. 6 is a perspective view of the electrical connector assembly shown in FIG. 4;

FIG. 7 is a plan view of the electrical connector assembly shown in FIG. 6;

FIG. 8 is a front view of the electrical connector assembly shown in FIG. 6;

FIG. 9 is an exposed view of the contacts and insulative housing shown in FIG. 6;

FIG. 10 is a perspective view of the contacts and insulative housing shown in FIG. 6, after forming the front end portion on a front end;

FIG. 11 is a partially exposed view of the contacts, the insulative housing and the front end portion shown in FIG. 10;

FIG. 12 is a front view of the electrical connector assembly shown in FIG. 8, removing the main body; and

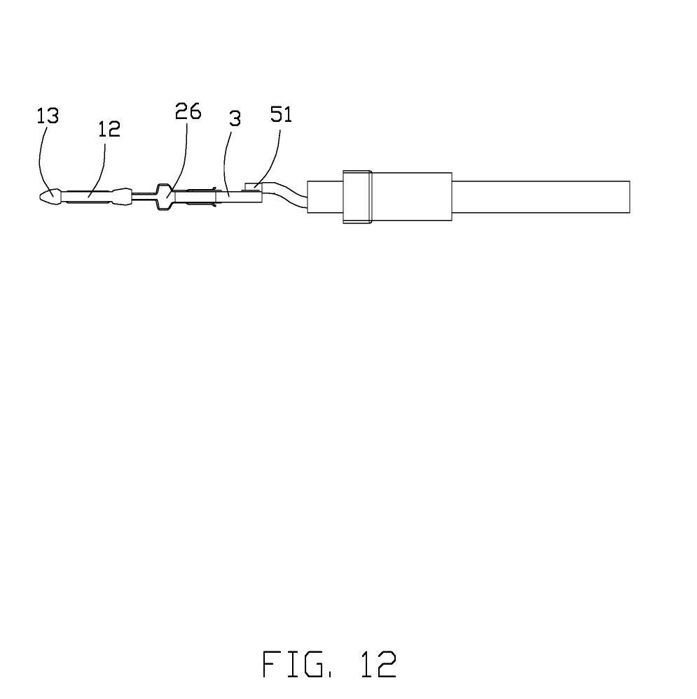

FIG. 13 is partially exploded view of the electrical connector assembly shown in FIG. 2, after the inner mold is molded.

FIG. 14 is a cross-sectional view of the electrical connector assembly shown in FIG. 1.

### DETAILED DESCRIPTION OF THE PREFERRED EMBODIMENT

Reference will now be made in detail to the preferred embodiment of the present invention.

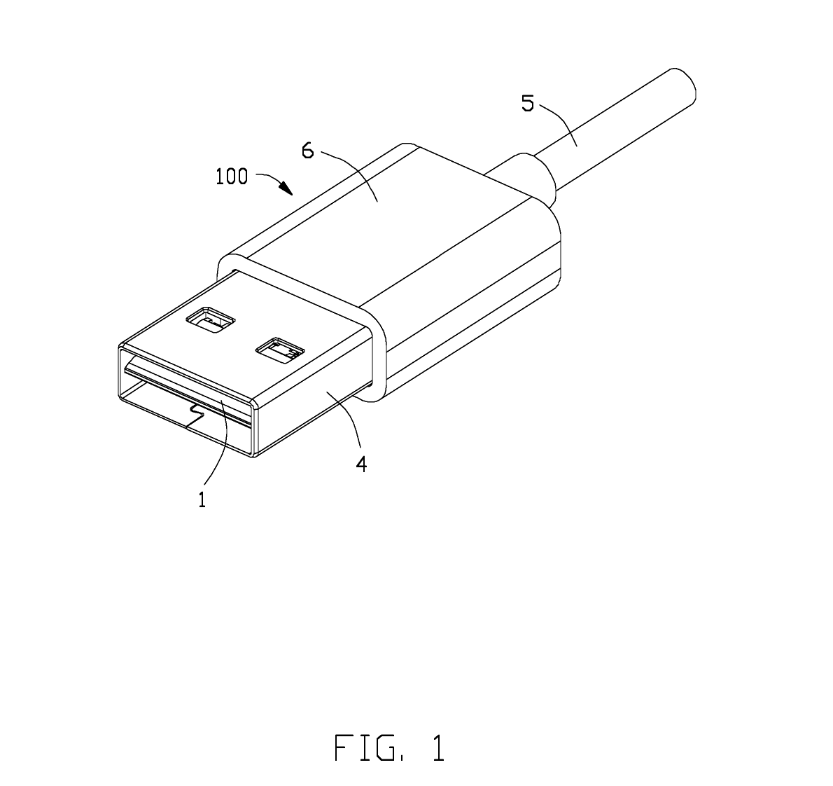

Referring to FIG. 1, the electrical connector assembly 100 according to the present invention includes a insulative housing 1, a plurality of contacts 2 retained in the insulative housing 1, a printed circuit board 3 electrically connected with the contacts 2, a shielding case 4 enclosed the insulative housing 1, a cable 5 electrically connected to a rear end of the printed circuit board 3, and a metal shell 6 covering the conjunction portion of the shielding case 4 and cable 5.

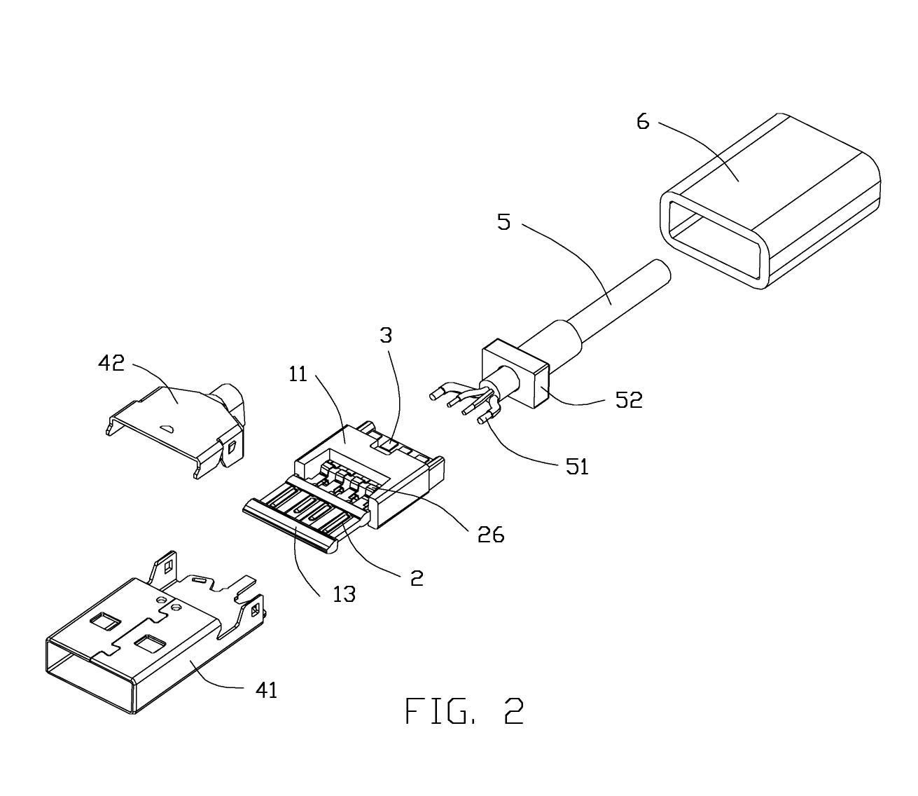

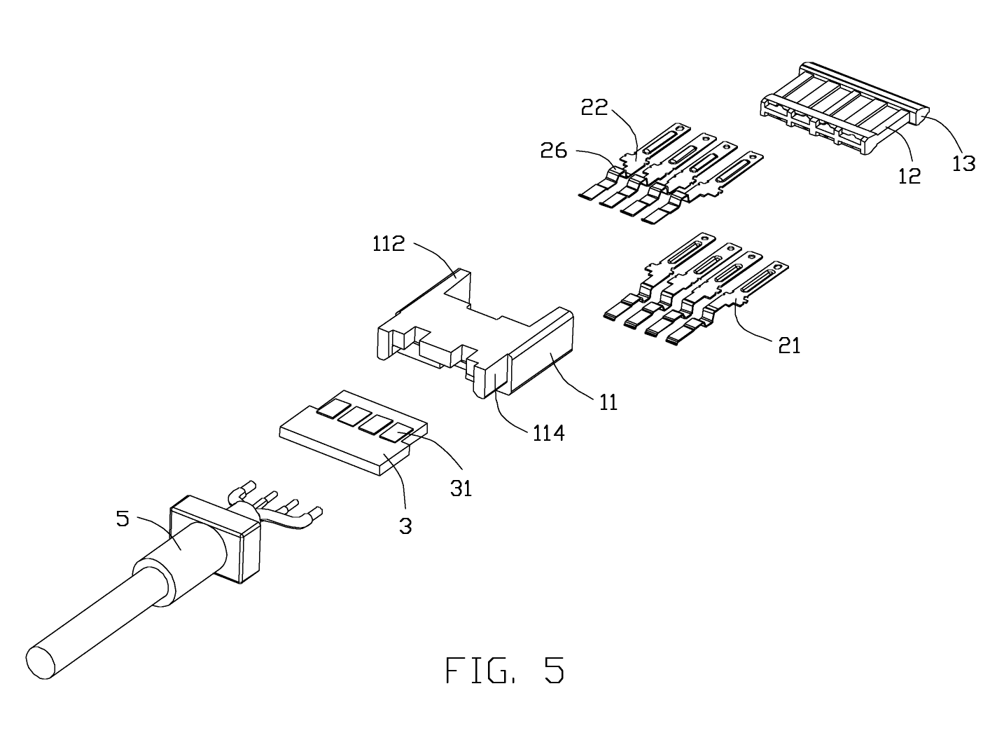

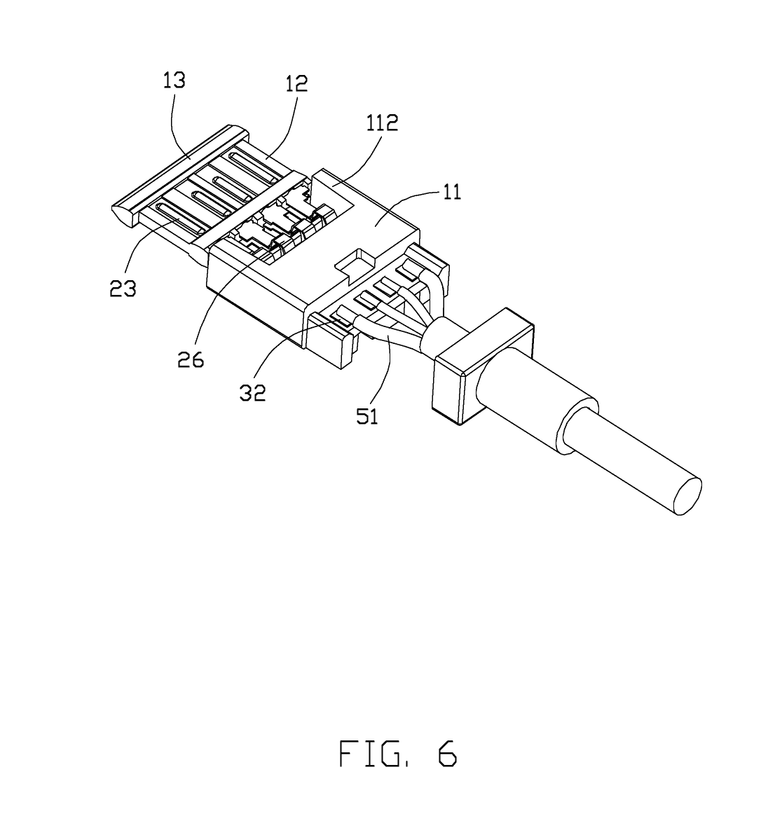

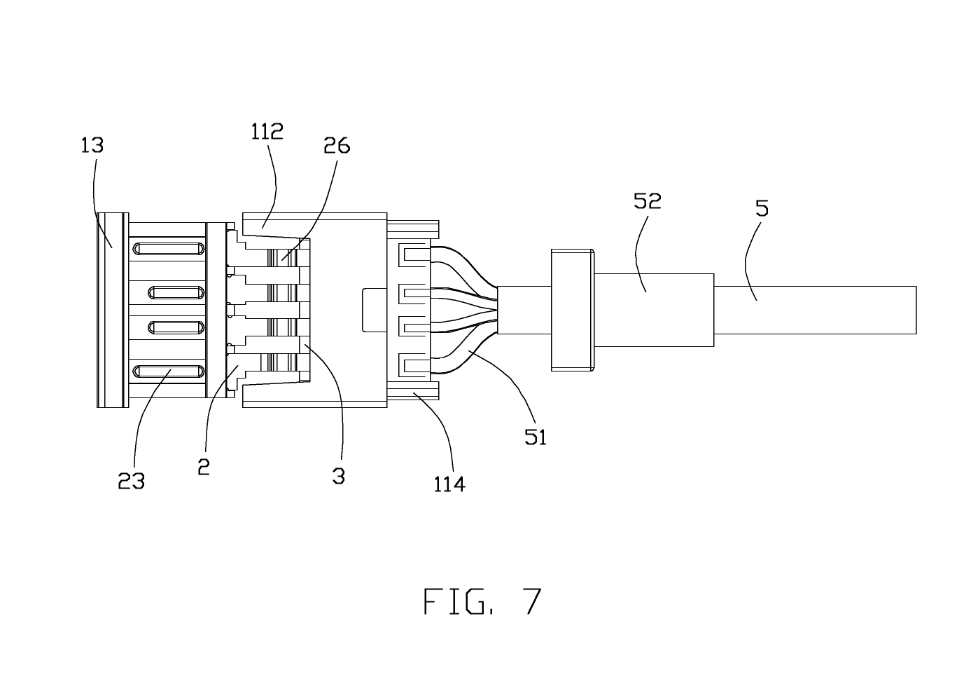

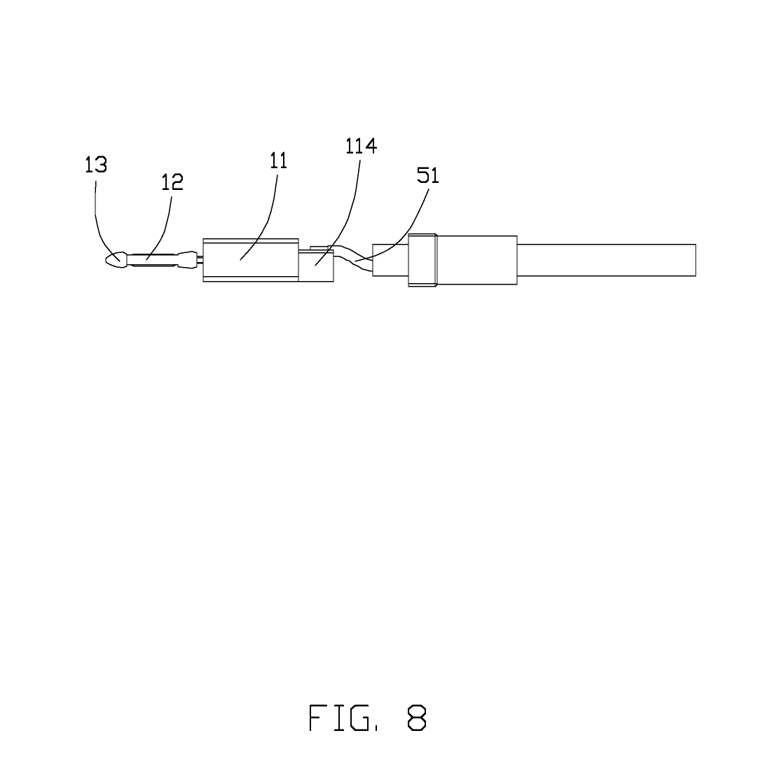

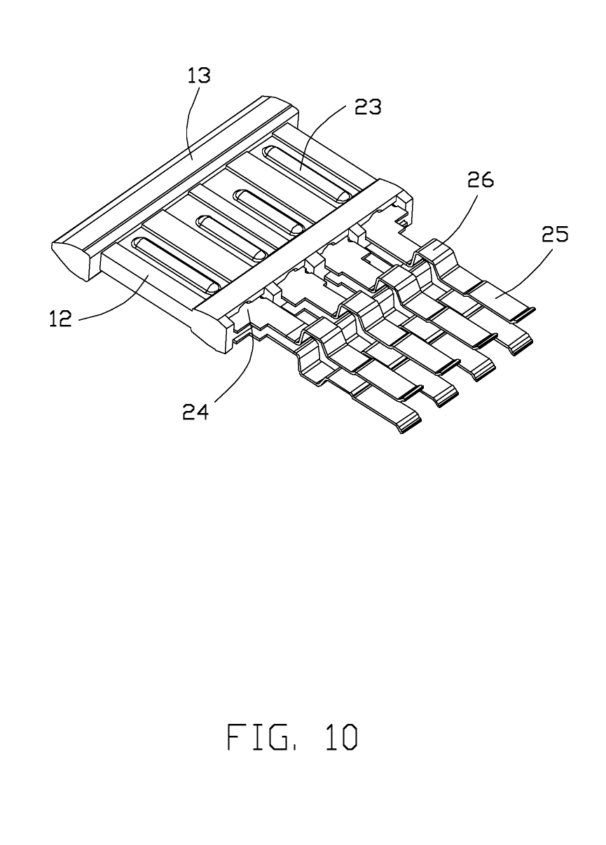

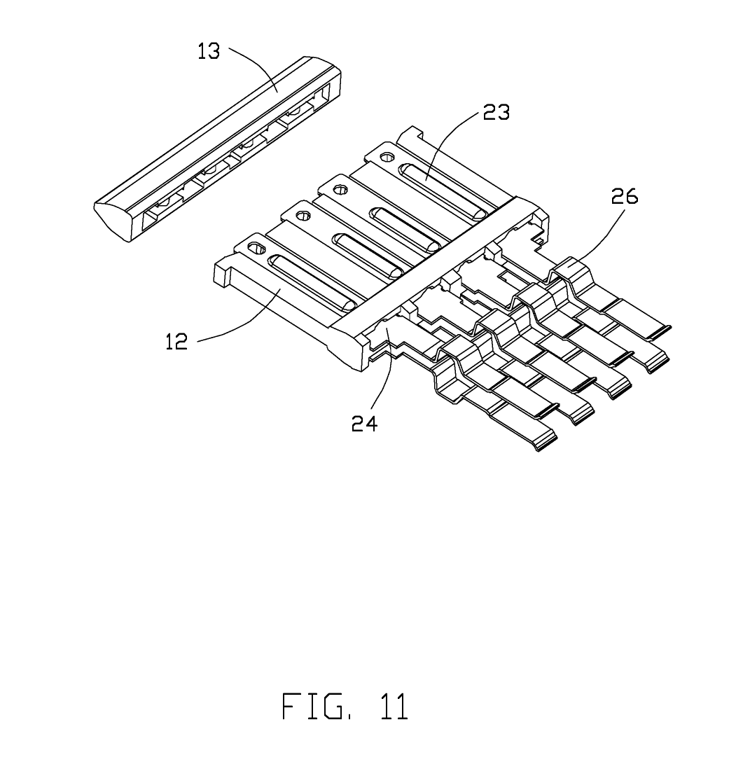

Referring to FIGS. 2-11, the insulative housing 1 includes a main body 11, a tongue portion 12 positioned on a front end of the main body 11, and a front end portion 13 forming on a front end of the tongue portion 12. The main body 11 defines a base portion 110, a pair of stopping arm 112 forwardly extending from two opposite sides of the base portion 110 respectively, a receiving slot 113 rearwardly extending from a front surface of the base portion 110, and a pair of wing portion 114 rearwardly protruding from two opposite sides of a rear end of the base portion 110 respectively. Each of the stopping arms 112 frontwardly extending from the front surface of the base portion 110, and the width of which gradually reduces along a rear-to-front direction, with two relative inner surfaces obliquely extending along the rear-to-front direction and forming a outstretched front opening The top and bottom surfaces of the tongue portion 12 define a plurality of receiving passageways 121 side by side in a lateral direction. The width of the tongue portion 12 is greater than the width between the two relative inner surfaces of the stopping arms 112, and smaller than the width between the two outside surfaces of the stopping arms 112.

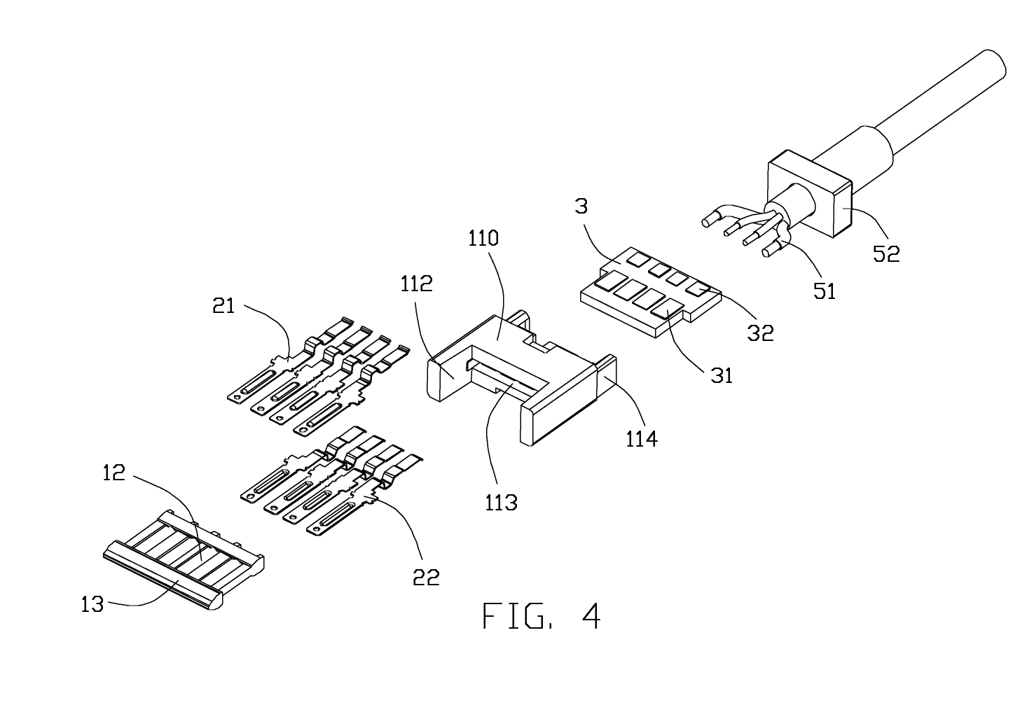

Referring to FIGS. 4-5 and 9-11, the contacts 2 include a plurality of upper row contacts 21 and a plurality of lower row contacts 22, wherein both of the upper row contacts 21 and lower row contacts 22 having four terminals, the upper row contacts 21 from left to right sequentially corresponding to the lower row contacts 22 from right to left respectively, thus the upper row contacts 21 and lower row contacts 22 connected with right mating terminals of a mating connector whether positive or anti-insert plugged. Each of the contacts 2 has a contacting portion 23 upwardly projecting, a fixing portion 24 interference fit with the tongue portion 12, a tail portion 25 electrically connected with the printed circuit board 3, and a bent portion 26 connected between the fixing portion 24 and tail portion 25. The contacting portion 23 of the upper row contacts 21 is of a convex shape extending upwardly. The contacting portion 23 of the lower row contacts 22 is of a convex shape extending downwardly. The bent portion 26 of the upper row contacts 21 is of an “n” shape bent and protruded upwardly. The bent portion 26 of the lower row contacts 22 is of an “n” shape bent and protruded downwardly. In brief, the upper row contacts 21 is a mirrored image of the lower row contacts 22 relative to the plane located between the upper row contacts 21 and the lower row contacts 22.

The upper and bottom surfaces of a front end of the printed circuit board 3 define a plurality of first conductive pads 31, and the first conductive pads 31 positioned on the upper and bottom surface are electrically connected with the corresponding contacts 2 located on the upper row and the lower row. The upper surface of a rear end of the printed circuit board 3 defines a plurality of second conductive pads 32, and the second conductive pads 32 positioned on the upper and bottom surfaces are electrically connected with a plurality of corresponding core wires 51 of the cable.

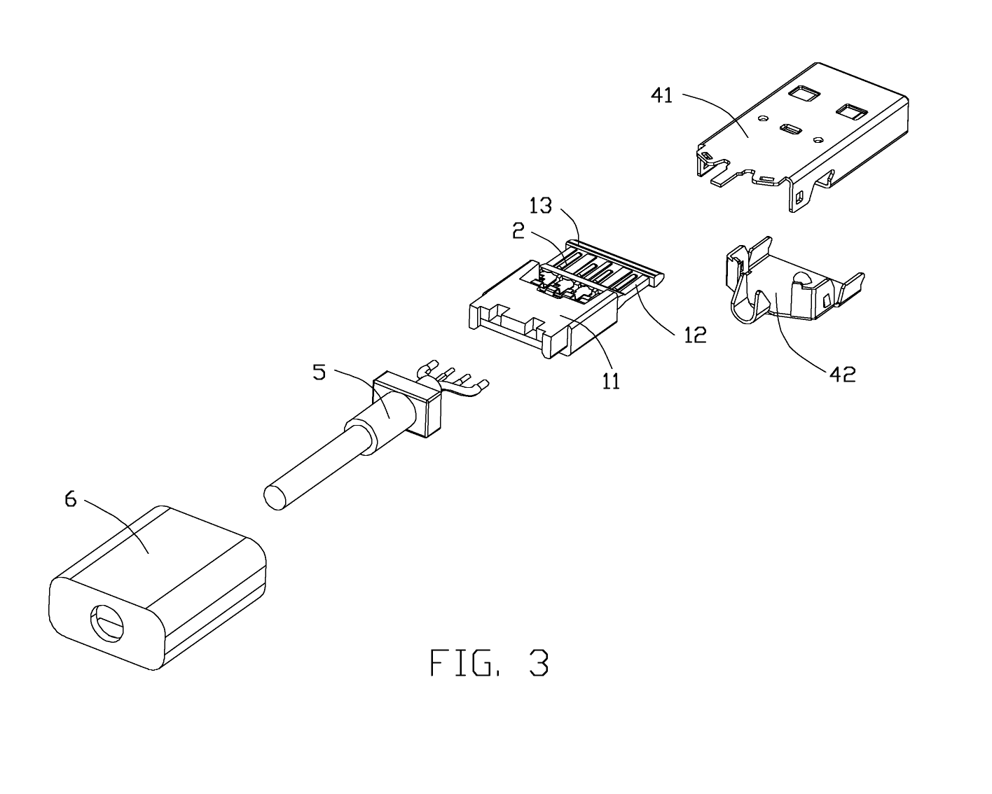

Referring to FIGS. 3 and 4, the shielding case 4 is made of metallic material. The shielding case 4 includes a front case 41 and a rear case 42 engaged with the front case 41. A front end of the cable 5 molds a stress relief portion 52.

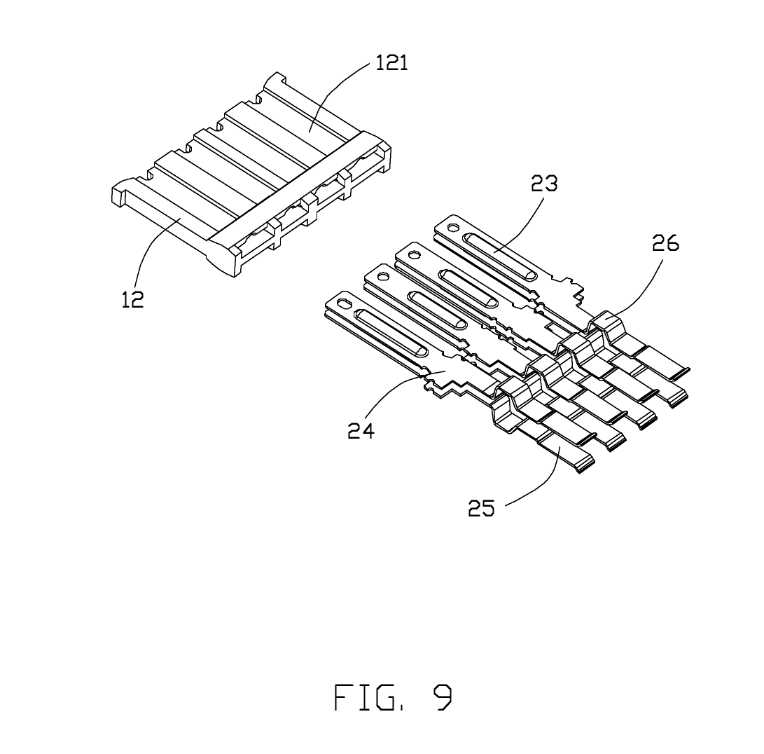

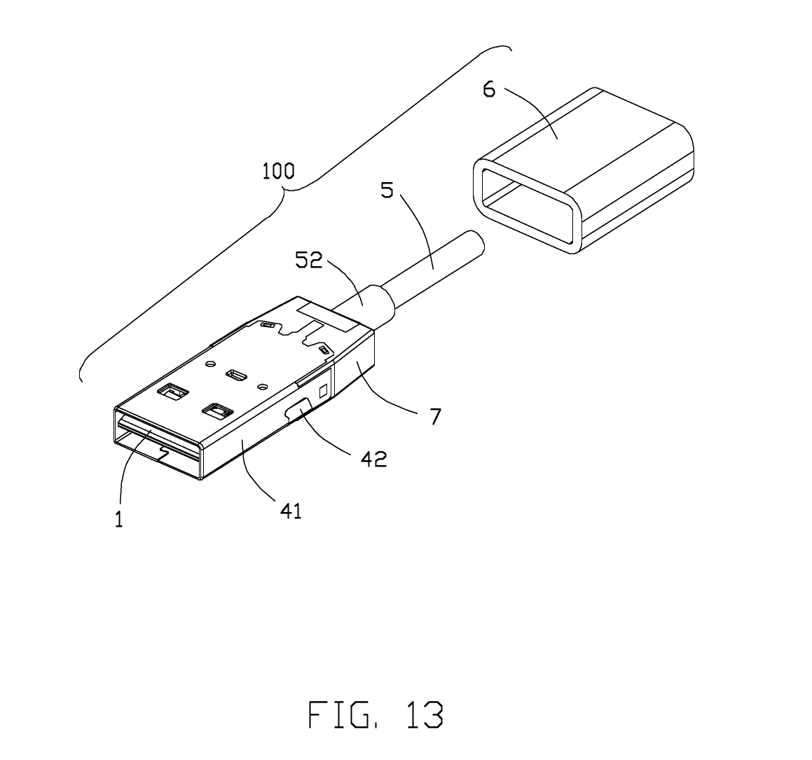

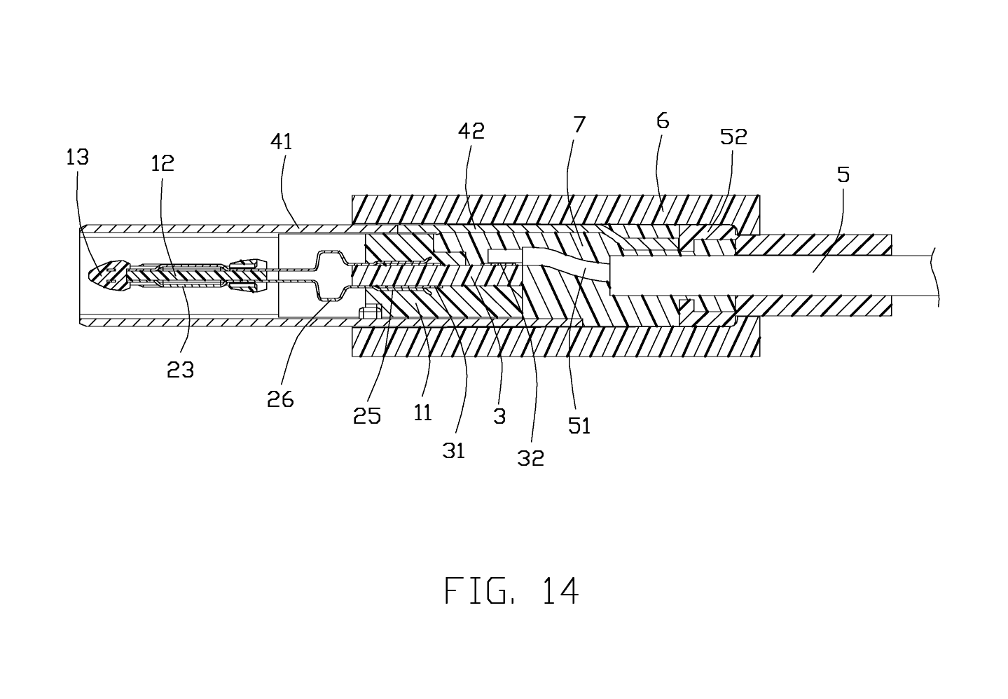

Referring to FIGS. 9 and 13-14, when assembling, the upper and lower row contacts 21, 22 are inserted into the corresponding receiving passageways 121 of the tongue portion 12. The fixing portion 24 of the contacts 2 are interference fit with the rear end of the tongues portion 12. The front end portion 13 is molded on the front end of the contacts 2 and the tongues portion 12, to make the front end portion 13 molded on the upper and lower row contacts 21, 22 simultaneously, solving technical difficulties of one-shot molding and the high cost problem or other issues, while increasing the retention of the butt end of the cable connector assembly 100. The contacting portion 23 of the contacts 2 are exposed on the upper and bottom surfaces of the tongue portion 12.

The front end portion 13, the tongue portion 12, and the contacts 2 are combined into one structure, enhancing the overall rigidity of the butt end of the cable connector assembly 100, concentrating the bending stress generated by the deflection along the vertical direction of the butt end to the contact area that the bent portion 26 is located, thus preventing rear end of the contacts 2 from permanent deformation, while avoiding to directly pull the solder joints on the printed circuit board 3.

The tail portions 25 of the contacts 2 are soldered with the corresponding first conductive pads 31 positioned on the front end of the printed circuit board 3. The main body 11 encloses the conjunction portion of the tail portions 25 and the first conductive pads 31, to protect the joints and ensure welding strength. In this embodiment, such a main body 11 is essentially overmolded upon the front region of the printed circuit board 3 including the aforementioned tail portions 25 and the first conductive pads 31, thus assuring that the tongue portion 12 with the corresponding contacts 2 functions in a reliable cantilevered manner with a root at those protectively hidden tail portions 25. The rear end of the printed circuit board 3 is located between the wing portions 114. The bent portions 26 of the contacts 2 are arranged between the stopping arms 112 side by side. The core wires 51 of the cable 5 are soldered on the corresponding second conductive pads 32 of the printed circuit board 3. The inner mold 7 is molded on the conjunction portion of the cable 5 and printed circuit board. Then the above-mentioned assembly is inserted into the front case 41, and the rear case 42 is assembled on the front case 41. The overmolded shell 6 covers the shielding case 4 and the inner mold 7.

The cable connector assembly 100 according to the present invention is inserted into the mating connector, the tongue portion of the mating connector is contacted with the stopping arms 112 defined on the two opposite sides of the insulative housing 1, and resisted by the stopping arms 112, thereby preventing the cable connector assembly 100 from being inappropriately inserted. Another feature of the invention is to have the each contact 2 experience two-shot molding process, i.e., one at the rear tail portion 25 with the main body 11 and the other at the front tip with the end portion 13 while the middle portion is not molded with the tongue portion 12 but being inserted into the corresponding passageway 121 and retained therein by the corresponding fixing portion 24. In other words, the manufacturing method of the instant invention essentially is a hybrid type including the assembling step, i.e., the fixing portions 24 with regard to the tongue portion 12, and several overmolding processes, i.e., a first molding between the front tips of the contacts 2 and the front end portion 13, a second molding between the main body 11 and the printed circuit board 3 with the tail portions 25 of the contacts 2 soldered thereon, and a third molding among the inner mold 7 and the combination of the cable 5, the rear case 42, the main body 11 and the printed circuit board 3.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector assembly comprising:
an insulative housing;
an upper row of contacts and a lower row of contacts received by the insulative housing;
a printed circuit board assembled on a rear end of the insulative housing and electrically connected with the contacts;
a shielding case enclosing the insulative housing; and
a cable connected with a rear end of the printed circuit board; wherein
the insulative housing includes a main body, a tongue portion positioned on a front end of the main body, and a front end portion formed on a front end of the tongue portion;
the front end portion is discretely molded on the tongue portion and on a front end of the contacts; and
each of the upper row of contacts and the lower row of contacts defines a contacting portion projecting outwardly, a fixing portion interference fitted with tongue portion, a tail portion electrically connected with the printed circuit board and a bent portion connected between the fixing portion and the tail portion.

2. The cable connector assembly as claimed in claim 1, wherein the upper row of contacts and the lower row of contacts comprise four terminals, respectively, the upper row of contacts from left to right sequentially corresponding to the lower row of contacts from right to left.

3. The cable connector assembly as claimed in claim 2, wherein the bent portion of the upper contact is of an “n” shape structure bent upwardly, the bent portion of the lower contact is of an inverted “n” shape structure bent downwardly.

4. The cable connector assembly as claimed in claim 3, wherein the contacting portion of the upper contact is of a convex structure projecting upwardly, the contacting portion of the lower contact is of a convex structure projecting downwardly, all the contacting portions being exposed to the upper and bottom surfaces of the tongue portion.

5. The cable connector assembly as claimed in claim 2, wherein an upper and lower surfaces of a front end of the printed circuit board is arranged a plurality of first conductive pads along a lateral direction, the first conductive pads are electrically connected to the upper and lower rows of contacts, an upper surface of a rear end of the printed circuit board is arranged a plurality of second conductive pads along the lateral direction, and the second conductive pads are electrically connected with the cable.

6. The cable connector assembly as claimed in claim 5, wherein the main body encloses on a conjunction portion of the contacts and the first conductive pads, and an inner mold is molded on a conjunction of the cable and the printed circuit board.

7. The cable connector assembly as claimed in claim 1, wherein the main body defines a base portion, a pair of stopping arms forwardly extending from two opposite sides of the base portion, and a pair of wing portions rearwardly extending from two opposite sides of a rear end of the base portion.

8. The cable connector assembly as claimed in claim 7, wherein a width between two outside walls of the pair of stopping arms is greater than a width of the tongue portion, and a width between two inside walls of the pair of stopping arms is smaller than the width of the tongue portion.

9. The cable connector assembly as claimed in claim 8, wherein the upper contact defines an “n” shape bent portion protruding upwardly, the lower contact defines an inverted “n” shape bent portion protruding downwardly, the bent portions are located between the pair of stopping arms of the main portion, and the rear end of the printed circuit board is positioned between the wing portions.

10. An electrical connector assembly comprising:
a cable connector including an insulative housing enclosed within a metallic shielding case,
said housing including a main body and a tongue portion located in front of and spaced from said main body in said front-to-back direction, said tongue portion forming opposite upper and lower faces in a vertical direction perpendicular to said front-to-back direction;
a printed circuit board including a front region embedded within the main body via an overmolding process, said printed circuit board forming opposite upper and lower surfaces in said vertical direction;
upper and lower row contacts attached upon said tongue portion and said printed circuit board, each of said upper and lower row contacts including a front contacting portion, a rear tail portion and a middle fixing portion therebetween in the front-to-back direction, the front contacting portions of the upper row contacts positioned upon the upper face of the tongue portion, the rear tail portions of the upper row contacts soldered upon the upper surface of a front portion of the printed circuit board while the front contacting portions of the lower contacts positioned upon the lower face of the tongue portion and the rear tail portion of the lower contacts soldered upon the lower surface of the front portion of the printed circuit board; wherein
the rear tail portions of both said upper and lower row contacts are protectively hidden within the main body in said vertical direction.

11. The electrical connector assembly as claimed in claim 10, wherein the tongue portion defines a plurality of passageways, and the fixing portions of the upper and lower row contacts are secured within the corresponding passageways, respectively, by forward inserting said contacts into the corresponding passageways, respectively.

12. The electrical connector assembly as claimed in claim 11, further including an insulative front end portion attached to front tips of said upper and lower row contacts and a front edge region of the tongue portion by an insert-molding process.

13. The electrical connector assembly as claimed in claim 11, wherein each of said upper and lower row contacts further includes a bent portion exposed outside of the main body and located between the corresponding tail portion and the corresponding fixing portion in the front-to-back direction and extending in the vertical direction for absorption of forces concentrated thereon during deflection of the tongue portion.

14. The electrical connector assembly as claimed in claim 11, wherein the contacting portion of each of said upper and lower row contacts is spaced from the corresponding upper or lower faces of the tongue portion with a gap in the vertical direction.

15. The electrical connector assembly as claimed in claim 11, wherein a front tip region of each of said upper and lower row contacts defines a hole into which the front end portion extends in the vertical direction.

16. The electrical connector assembly as claimed in claim 11, further including a cable with a plurality of wires mechanically and electrically connected to at least one surface of a rear portion of the printed circuit board, wherein an inner mold is applied upon the rear portion of the printed circuit board and a front portion of the cable and a rear region of the shielding case.

17. A method of making an electrical connector comprising steps of:
providing an insulative tongue portion with upper and lower row passageways opposite to each other in a vertical direction;
providing upper and lower row contacts, each of said upper and lower row contacts having a front contacting portion, a rear tail portion and a middle fixing portion in a front-to-back direction perpendicular to said vertical direction;
inserting the upper and lower row contacts into the corresponding upper and lower row passageways, respectively, to have the fixing portion of each of said contacts retained in the corresponding passageway;
providing a printed circuit board behind the tongue portion with opposite upper and lower surfaces thereon;
soldering the tail portions of said upper and lower row contacts upon said upper and lower surfaces of a front portion of the printed circuit board;
applying an insulative main body upon said upper and lower surfaces of the front portion of the printed circuit board via an overmolding process so as to have the rear tail portions of said upper and lower row contacts protectively hidden within the main body and have the tongue portion with the corresponding upper and lower row contacts function in a cantilevered manner with a root at said rear tail portions; and
attaching a metallic shielding case upon the housing to enclose said tongue portion.

18. The method as claimed in claim 17, further including a step of attaching an insulative front end portion to both exposed front tips of the upper and lower row contacts and an exposed front edge region of the tongue portion via a molding process so as to shield both the front edge region of the tongue portion and front tips of the upper and lower row contacts in the front-to-back direction.

19. The method as claimed in claim 18, wherein in each of said upper and lower row contacts, a bent portion is exposed outside of the main body and located between the corresponding fixing portion and the corresponding tail portion in the front-to-back direction and extends in the vertical direction for absorption of forces concentrated thereon during deflection of the tongue portion.

20. The method as claimed in claim 18, further including a step of soldering wires of a cable upon a rear portion of the printed circuit board, and another step of overmolding an inner mold upon the rear portion of the printed circuit board and a front portion of the cable; wherein said inner mold is located within a rear portion of the shielding case.
